(19) United States
(12) Patent Application Publication
(10) Pub. No.: US 2015/0115803 A1
(43) Pub. Date: Apr. 30, 2015

(54) HEAD LAMP

(71) Applicants: Michael Mackool, Royal Oak, MI (US); Luke Orlins, Berkley, MI (US)

(72) Inventors: Michael Mackool, Royal Oak, MI (US); Luke Orlins, Berkley, MI (US)

(21) Appl. No.: 14/065,746

(22) Filed: Oct. 29, 2013

(51) Int. Cl. H05B 33/08; H05B 37/02

(52) U.S. Cl. CPC H05B 33/0803; H05B 37/0218
USPC 315/152

(57) ABSTRACT

A head lamp assembly wearable by a user or attachable to an object comprising a substrate, a first light source, a second light source, and a sensor. The sensor can turn the first and second light sources ON when light striking the sensor falls below a predetermined intensity level. The sensor can turn the first and second light sources OFF when light striking the sensor exceeds a predetermined intensity level. An override switch can allow user to keep the light sources either completely illuminated or obfuscated, irrespective of the sensor.

### FIELD

The present disclosure relates to a light source and, more specifically, to a light source worn by a user or attached to an object.

### BACKGROUND

This section provides background information related to the present disclosure which is not necessarily prior art.

Head lamps are typically worn by construction workers to illuminate dark or unlit environments without requiring the workers to hold flash lights or install light sources. Moreover, by wearing a head lamp and illuminating an area where a worker is present and/or working, a head lamp can also further the worker's safety by alerting others of the worker's presence in the environment.

Generally, a worker wearing a head lamp and desiring to illuminate a dark or unlit environment must turn the head lamp ON in order to generate the desired illumination. Typically, this requires the worker to activate a switch, usually located somewhere on the head lamp. To activate the switch, the worker can either remove the head lamp from her head, find and activate the switch, and then reposition the head lamp back on her head; or, the worker can leave the head lamp on her head and rely on her mental recollection of the location of the switch on the head lamp and on her sense of touch to find and activate the switch. Then, once the worker is no longer present in the dark or unlit environment, and no longer requires the head lamp to generate the previously desired illumination, the worker must remember to turn the head lamp OFF, or risk unnecessary battery drain. The process of turning the head lamp ON and subsequently remembering to turn the head lamp OFF can be tedious and burdensome for the worker, especially if the worker frequently travels between a dark or unlit environment and a light or lit environment.

### SUMMARY

This section provides a general summary of the present disclosure, and is not a comprehensive disclosure of its full scope or all of its features.

In one form, the present disclosure provides an assembly comprising a substrate wearable by a user or attachable to an object. A sensor power source, a first light power source, and a second light power source are attached to the substrate. A sensor is attached to the substrate and is electrically connected to the sensor power source. A first light source is attached to the substrate and is electrically connected to the sensor and to the first light power source. A second light source is attached to the substrate and is electrically connected to the sensor and to the second light power source. The sensor is operable to turn ON the first light source and the second light source when light striking the sensor falls below a first predetermined intensity level whether or not the assembly is in motion. The sensor is further operable to turn OFF the first light source and the second light source when light striking the sensor exceeds a second predetermined intensity level. The first predetermined intensity level and the second predetermined intensity level is the same or different, and the sensor power source, the first light power source, and the second light power source are the same or different.

In another form, a head lamp assembly contains an elastic band and at least one task light attached to the elastic band and electrically connected to a rechargeable battery. The head lamp assembly further has a plurality of hazard lights attached to the elastic band and electrically coupled to a rechargeable battery that is the same as or different from the rechargeable battery coupled to the task light. It also has a means for turning ON the at least one task light and the plurality of hazard lights without any user interaction in response to a low light level regardless of whether the headlight assembly is in motion, and for turning OFF the at least one task light and the plurality of hazard lights without any user interaction in response to a high light level. The head lamp assembly also has at least one switch accessible by a user to override the means.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only. They illustrate selected embodiments—not all possible implementations—and are not intended to limit the scope of the present disclosure.

FIG. 1 is a perspective view of a head lamp assembly of the present disclosure;

FIG. 2 is a partial perspective view of the head lamp assembly of the FIG. 1; and

FIG. 3 is an exploded view of an electrical enclosure of the head lamp assembly of FIG. 1.

Corresponding reference numerals indicate corresponding parts throughout the several views of the drawings.

### DETAILED DESCRIPTION

Example embodiments will now be described more fully with reference to the accompanying drawings.

The following description is merely exemplary in nature and is not intended to limit the present disclosure, application, or uses. For purposes of clarity, the same reference numbers will be used in the drawings to identify similar elements.

Examples are provided so that this description will be thorough, and will fully convey the scope to those who are skilled in the art. Numerous specific details are set forth such as examples of specific components and methods, to provide a thorough understanding of examples of the present disclosure. It will be apparent to those skilled in the art that specific details need not be employed, that examples may be embodied in many different forms and that neither should be construed to limit the scope of the description.

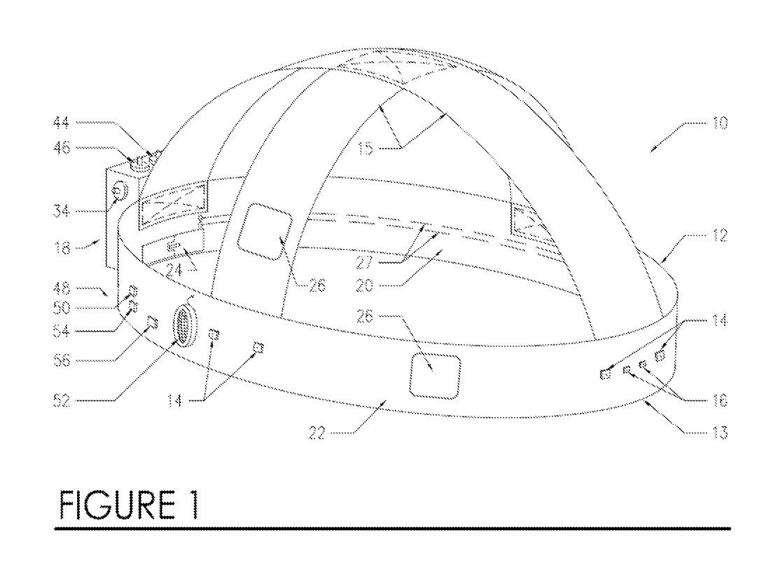

With reference to FIG. 1, a head lamp assembly 10 is illustrated. The head lamp assembly 10 comprises a substrate 12, and disposed upon the substrate 12, a plurality of hazard lights 14, at least one task light 16, and an electrical enclosure 18.

The substrate 12 is generally linear and can be fabricated from a suitable material, such as elastic or nylon. The substrate 12 comprises an inner surface 20, an outer surface 22, an attachment feature 24 and a retention strap 15.

As will be described further below, coupled to the outer surface 22 of the substrate 12 can be the plurality of hazard lights 14, the at least one task light 16, and the electrical enclosure 18. The outer surface 22 of the substrate 12 and the retention strap 15, described below, can further include a reflector 26. In an embodiment, the reflector 26 can cover the entire outer surface 22 of the substrate 12 and the retention strap 15. Regardless of the size and placement of the reflector 26, when an auxiliary light is directed towards the reflector 26, the reflector 26 can reflect the auxiliary light. Therefore, the reflector 26 can provide an additional safety benefit to the user of the head lamp assembly 10 or to the object upon which the head lamp assembly 10 is mounted, especially if the head lamp assembly 10 is turned OFF, if the hazard lights 14 are turned OFF, and/or if the at least one task light 16 is turned OFF, as will be described further below.

The attachment feature 24 is attached to the substrate 12 and can be, for example, an engagable buckle or clasp. As illustrated in FIG. 1, when the attachment feature 24 is engaged, the substrate 12 can take the shape of a circular band 13. The circular band 13 can be adapted to fit around, for example, a construction worker's protective safety hard hat or a bicycle safety helmet (not illustrated). The attachment feature 24 can also provide a means for adjusting the size of the circular band 13 to fit, for example, more snuggly around a protective safety hard hat or a bicycle safety helmet. The attachment feature 24, whether engaged or not engaged, can also be used to mount the head lamp assembly 10 upon another object such as, for example, a bicycle frame, a child's wagon or a fence post (not illustrated).

The retention strap 15 can also be fabricated from a suitable material, such as elastic or nylon and can be attached to either the inner surface 20 or the outer surface 22 of the substrate 12. The retention strap 15 can be used to, for example, assist a user in securing and retaining the head lamp assembly 10 around a protective safety hard hat or a bicycle safety helmet. The retention strap 15 can also provide for a more snug-fit when the head lamp assembly 10 is worn directly around a user's head. In an embodiment, the retention strap 15 can be removeably attached to the substrate 12, to provide a user with the ability to customize the shape and fit of the head lamp assembly 10 during use.

As was briefly described above, the plurality of hazard lights 14 can be coupled to the outer surface 22 of the substrate 12. The hazard lights 14 can be light emitting diodes (LEDs), however, halogen, fluorescent or any other suitable light source can be substituted for, or used in combination with, the LEDs. When turned ON, as will be described further below, the hazard lights 14 can emit an amber color light, however, other colors such as, for example, red and/or natural white light can also be emitted depending on the type of light source used. Moreover, when the attachment feature 24 is engaged and the substrate 12 is formed into the circular band 13, the hazard lights 14, when turned ON, can provide 360 degrees of illumination.

As was also briefly described above, the at least one task light 16 can also be coupled to the outer surface 22 of the substrate 12. The task light 16 can comprise a single light source, or can comprise a plurality of light sources, as is illustrated in FIG. 1. Like the hazard lights 14, the task light(s) 16 can also be light emitting diodes (LEDs), however, halogen, fluorescent or other suitable light sources can be substituted for, or used in combination with, the LEDs. When turned ON, as will be described further below, the task light(s) 16 can emit a bright white color light, however, other colors, such as, for example, red and/or amber can be emitted depending on the type of light source used.

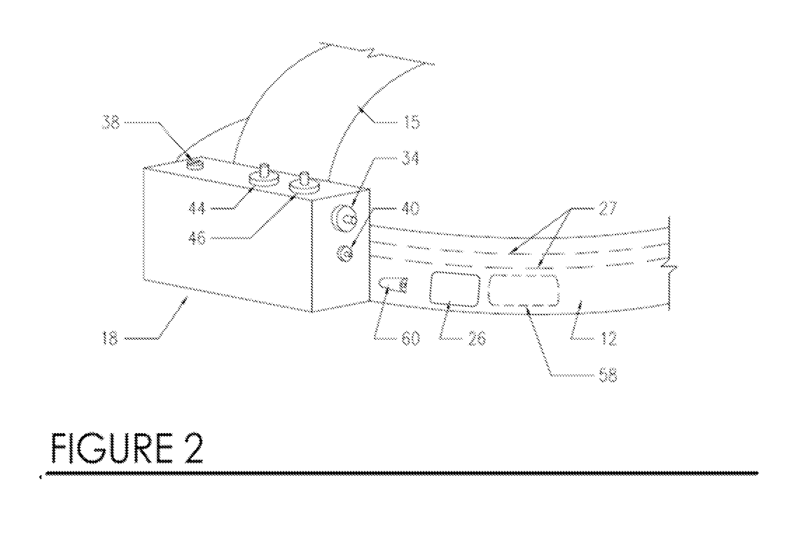

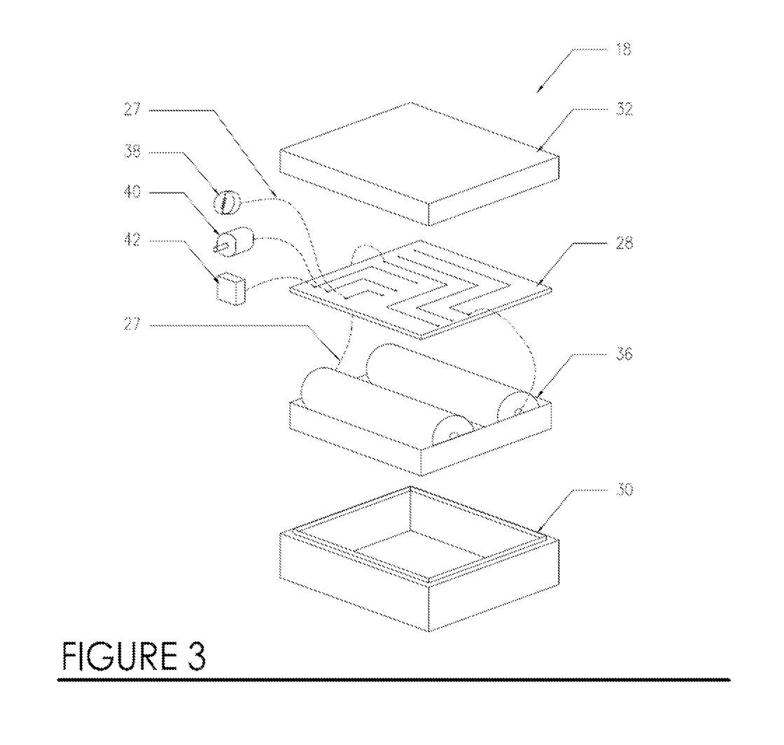

With reference to FIGS. 1-3, the hazard lights 14 and the task light(s) 16 can be electrically connected to a circuit board 28 with electrical wires 27. The circuit board 28 and the electrical wires 27 are of the type generally known and used in typical electrical systems and will therefore not be described in detail herein. The electrical wires 27 can be embedded within the substrate 12, between the inner and outer surfaces 20, 22. In addition to electrically connecting the lights 14, 16 to the circuit board 28, the electrical wires 27 can also electrically connect other components of the head lamp assembly 10 to the circuit board 28, as will be described below. The circuit board 28 can be contained within the electrical enclosure 18, described below.

The electrical enclosure 18 can be a hollow structure coupled to the outer surface 22 of the substrate 12. The electrical enclosure 18 can comprise a base 30 and a cover plate 32. Both the base 30 and the cover plate 32 can be fabricated from a suitable plastic material that is preferably waterproof. The cover plate 32 can be removeably secured to the base 30 with at least one suitable fastener (not illustrated). Accordingly, the cover plate 32 can be separated from the base 30 to, for example, provide access to the circuit board 28 and to the other components contained within the electrical enclosure 18.

In addition to the circuit board 28, the electrical enclosure 18 can also contain a main ON/OFF user switch 34, a power source 36, a sensor 38, a potentiometer 40, and a light sync 42.

The main ON/OFF user switch 34 can be mounted on the electrical enclosure 18 and is electrically connected to the circuit board 28. The main ON/OFF user switch 34 can be, for example, a push-button type switch, a touch-sensitive switch, or any other suitable switch. The main ON/OFF user switch 34 can provide a user with the ability to control the head lamp assembly 10. For example, during use, when the main ON/OFF user switch 34 is in the ON position, electrical power can be transferred from the power source 36, described below, to any of the electrical components connected to it, also described below. In contrast, when the main ON/OFF user switch 34 is in the OFF position, electrical power is restricted from transferring from the power source 36 to any of the electrical components connected to it.

In an illustrative embodiment, the power source 36 is a single, 3.7 volt lithium ultra-thin rechargeable battery. The power source 36 is electrically connected to the circuit board 28 with the electrical wires 27, and is contained within the electrical enclosure 18. In an embodiment, the power source 36 is embedded within the substrate 12, between the inner and outer surfaces 20, 22. The power source 36 can also comprise a plurality of rechargeable batteries of varying sizes and voltages that can be recharged by electrically connecting the head lamp assembly 10 to a power source such as, for example, a wall outlet or an auxiliary power outlet in a vehicle (not illustrated). The power source(s) 36 can also be recharged by placing the head lamp assembly 10 upon a magnetic rechargeable pad or by using a wireless solar light charging means (not illustrated).

As illustrated, the sensor 38 is also electrically connected to the circuit board 28 with the electrical wires 27, and mounted on the electrical enclosure 18. The sensor 38 can be a typical light sensor, as is known in the field. During use, when the main ON/OFF user switch 34 is in the ON position, the sensor 38 can survey the environment surrounding the sensor 38 and the head lamp assembly 10 for the presence of visible light. Should the sensor 38 detect visible light in the surrounding environment that exceeds a predetermined intensity level, the sensor 38 can generate and send a first electronic signal to the circuit board 28 and turn the lights 14, 16 OFF and keep the lights 14, 16 OFF. Conversely, should the sensor 38 not detect the presence of visible light in the surrounding environment, that is, if the presence of visible light in the surrounding is below a predetermined intensity level, the sensor 38 can generate and send a second electronic signal to the circuit board 28 to turn the lights 14, 16 ON and keep the lights 14, 16 on. It should be understood that the first and the second signals sent by the sensor 38 can be the same or different.

It should also be understood that the sensor 38 can either turn the lights 14, 16 OFF or turn the lights 14, 16 ON, depending on the presence or absence of visible light, respectively, in the surrounding environment relative to a predetermined intensity level. More specifically, the sensor 38 does not operate to increase the illumination intensity of the lights 14, 16 or decrease the illumination intensity of the lights 14, 16 in proportion to the amount of visible light that is present or absent, respectively, in the environment surrounding the head lamp assembly 10.

In an embodiment, however, the sensor 38 can dim the lights 14, 16 depending on the amount of visible light in the environment surrounding the sensor 38 relative to a predetermined intensity level. For example, should the amount of visible light in the environment surrounding the sensor 38 be slightly greater than or slightly less than a predetermined intensity level, the illumination intensity of the lights 14, 16 may be dimmed, as opposed to being either turned OFF or ON, respectively.

Moreover, the sensor 38 can operate to turn the lights 14, 16 OFF and/or turn the lights 14, 16 ON in the above described manor regardless if the head lamp assembly 10 is in motion. For example, should a user desire to place the head lamp assembly 10 upon a stationary or inanimate object, or should a user wearing the head lamp assembly 10 be inactive for a period of time, the lights 14, 16 can still turn ON and/or stay ON once the sensor 38 detects that the visible light in the environment surrounding the head lamp assembly 10 is below a predetermined intensity level. The ability of the head lamp assembly 10 to turn the lights 14, 16 ON and/or keep the lights 14, 16 ON regardless if the head lamp assembly 10 is in motion provides a user with numerous benefits. For example, as was briefly described above, the head lamp assembly 10 can be placed upon an inanimate object, such as, for example, a fence post or a mailbox and illuminate a dark or unlit area and/or provide notification of the object's presence to others.

The potentiometer 40 can be electronically connected to the circuit board 28 with the electrical wires 27, and can be mounted on the electrical enclosure 18. The potentiometer 40 can enable a user to adjust either or both of the predetermined intensity levels used by the sensor 38 to turn the lights 14, 16 ON and OFF. For example, a user may desire for the sensor 38 to turn OFF either or both of the lights 14, 16 as soon as a scintilla of light is detected by the sensor 38 in the environment surrounding the head lamp assembly 10, or, in contrast, keep the lights 14, 16 ON until the sensor 38 detects direct, bright light in the environment surrounding the head lamp assembly 10. A user can also adjust the potentiometer 40 to enable the sensor 38 to turn the lights 14, 16 ON and OFF when the light level in the surrounding environment is somewhere in between.

A hazard light override switch 44 and a task light override switch 46 can also be connected to the circuit board 28 with the electrical wires 27, and both switches 44, 46 can be mounted on the electrical enclosure 18. Each override switch 44, 46 can be a push-button type switch, a touch-sensitive switch, or any other like suitable switch. The override switches 44, 46 can enable a user to override the sensor 38. For example, during normal use of the head lamp assembly 10, as described above, when the visible light in the environment surrounding the sensor 38 and the head lamp assembly 10 is below the predetermined intensity level, the sensor 38 can generate and send the second electric signal to the circuit board 28 to turn ON the hazard light(s) 14 and the task lights 16. However, should a user desire to not have the hazard lights 14 illuminated when the visible light in the environment surrounding the sensor 38 is below the predetermined intensity level, the user can activate the hazard light override switch 44, override the second electric signal, and turn the hazard lights 14 OFF and/or keep the hazard lights 14 OFF. Similarly, should a user desire to turn the task light(s) 16 OFF and/or keep the task light(s) 16 OFF once the sensor 38 turns the task light(s) 16 ON, the user can activate the task light override switch 46 and override the second signal. Each of the override switches 44, 46 can also be used to allow a user to turn the lights 14, 16 ON and/or keep the lights 14, 16 ON once the sensor 38 generates and sends the first signal to turn the lights 14, 16 OFF.

The hazard light override switch 44 can also enable a user to control and adjust the illumination intensity or brightness generated by the hazard lights 14 when the hazard lights 14 are turned ON by the sensor 38. Further, a user can use the hazard light override switch 44 to enable the hazard lights 14, when turned ON, to either remain continuously illuminated or blink intermittently. Further, should a user desire the hazard lights 14 to blink intermittently when turned ON, the hazard light override switch 44 can also allow a user to adjust the frequency or speed of the blink. The task light override switch 46 can also enable a user to adjust and control the intensity or brightness of the illumination generated by the task lights 16 when the task lights 16 are turned ON.

The hazard light override switch 44 and the task light override switch 46 can provide a user with numerous benefits. For example, there may be situations where a user wearing the head lamp assembly 10 wishes to keep the lights 14, 16 ON, however, the visible light in the environment surrounding the head lamp assembly 10 is above the predetermined intensity level, such as, for example, on a cloudy day or during the dawn and/or the dusk hours. Moreover, should a user wearing the head lamp assembly 10 in a dark and/or unlit environment be in the presence of others wearing head lamps or holding flashlights, the user can use the override switches 44, 46 to keep the lights 14, 16 ON as opposed to the sensor 38 turning the lights 14, 16 OFF.

The light sync 42 can also be electronically connected to the circuit board 28 with the electrical wires 27, and can be contained within the electrical enclosure 18. During use, should a user desire the hazard lights 14 to blink intermittently, the light sync 42 can adjust and synchronize the blinking of the hazard lights 14 to blink in unison with other nearby blinking light sources. By providing a synchronized and unison blink with other nearby blinking lights, the risk of photosensitive epilepsy to a user or to another nearby person can be reduced.

Also attached to the substrate 12 can be an audible warning system 48. The audible warning system 48 can include a user switch 50 and at least one speaker 52. During use, a user can activate the user switch 50 to generate and disseminate an audible tone through the speaker 52. The audible warning system 48 can provide a means for a user to alert others of the worker's presence in an environment and/or provide a means for the user to signal for assistance. The audible warning system 48 can also comprise a microphone 54 and a transmitter 56. The microphone 54 and transmitter 56 can provide a user with the ability to communicate with others.

A flash memory 58 can also be coupled to the substrate 12. The flash memory 58 can provide the user with the ability to store data, such as, for example, media data that can be played through the speaker 52 of the audible warning system 48, described above. An audible jack 60 can also be incorporated into the substrate 12, to enable a user to connect headphones (not illustrated) to the flash memory 58 and listen to media files stored on the flash memory 58, for example.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly comprising:
a substrate wearable by a user or attachable to an object;
a sensor power source attached to the substrate;
a sensor attached to the substrate and electrically connected to the sensor power source;
a first light power source attached to the substrate;
a first light source attached to the substrate and electrically connected to the sensor and to the first light power source;
a second light power source attached to the substrate; and
a second light source attached to the substrate and electrically connected to the sensor and to the second light power source; wherein the sensor being operable to turn ON the first light source and the second light source when light striking the sensor falls below a first predetermined intensity level whether or not the assembly is in motion, the sensor being further operable to turn OFF the first light source and the second light source when light striking the sensor exceeds a second predetermined intensity level;
wherein, the first predetermined intensity level and the second predetermined intensity level is the same or different, and the sensor power source, the first light power source, and the second light power source are the same or different.

2. The assembly of claim 1 further comprising:
a main user switch for turning the assembly ON and OFF;
a first user switch being accessible for manual use for turning ON the first light source when the first light source is turned OFF by the sensor, the first user switch being further operable to turn OFF the first light source when the first light source is turned ON by the sensor; and
a second user switch being accessible for manual use for turning ON the second light source when the second light source is turned OFF by the sensor, the second user switch being further operable to turn OFF the second light source when the second light source is turned ON by the sensor, the second user switch being further operable to control the second light source to operate in a continuous light mode or in a blinking light mode when the second light source is turned ON by the sensor.

3. The assembly of claim 1, wherein the first light source comprises at least one white light LED coupled to the substrate.

4. The assembly of claim 1, wherein the second light source comprises a plurality of amber light LEDs coupled to the substrate.

5. The assembly of claim 2, wherein the second user switch is further operable to control a blinking frequency of the second light source when the second light source is operating in the blinking light mode.

6. The assembly of claim 2, wherein the first user switch is further operable to increase and decrease an intensity of light generated by the first light source when the first light source is turned ON.

7. The assembly of claim 2, wherein the second user switch is further operable to increase and decrease an intensity of light generated by the second light source when the second light source is turned ON.

8. The assembly of claim 1, wherein both the first predetermined intensity level and the second predetermined intensity level are adjustable.

9. The assembly of claim 1 further comprising an audible warning system coupled to the substrate and electrically connected to at least one of the power sources.

10. The assembly of claim 1 further comprising a light sync attached to the substrate and electrically connected to at least one of the power sources and the second light source.

11. The assembly of claim 1 further comprising a flash memory, a reflector, and a retention strap.

12. A head lamp assembly comprising:
a) an elastic band;
b) at least one task light attached to the elastic band and electrically connected to a rechargeable battery;
c) a plurality of hazard lights attached to the elastic band and electrically coupled to a rechargeable battery that is the same as or different from the rechargeable battery of b);
d) means for turning ON the at least one task light and the plurality of hazard lights without any user interaction in response to a low light level regardless if the headlight assembly is in motion, and for turning OFF the at least one task light and the plurality of hazard lights without any user interaction in response to a high light level; and
e) at least one switch accessible by a user to override the means of d).

13. The head lamp assembly of claim 12, wherein the plurality of hazard lights are disposed about the elastic band and emit a different color light than the at least one task light.

14. The head lamp assembly of claim 12, wherein the elastic band is reflective and adjustable.

15. The head lamp assembly of claim 12, wherein the at least one switch being operable to enable the plurality of hazard lights to blink or not blink when the plurality of hazard lights are turned ON, the at least one switch further being operable to control a brightness of the plurality of hazard lights when the plurality of hazard lights are turned ON.

16. The head lamp assembly of claim 12, wherein the at least one switch being operable to control a brightness of the at least one task light when the at least one task light is turned ON.

17. The head lamp assembly of claim 12, further comprising a main user switch for turning the means ON and OFF.

18. The head lamp assembly of claim 12, wherein the means of d) is adjustable.

19. The head lamp assembly of claim 12, wherein the at least one task light and the plurality of hazard lights comprise at least one of a LED, halogen or fluorescent bulb.

20. The head lamp assembly of claim 12 further comprising an audible warning system.
